(19) United States
(12) Patent Application Publication
(10) Pub. No.: US 2020/0070079 A1
(43) Pub. Date: Mar. 5, 2020

(54) Filtration System

(71) Applicants: Jeong Hwa SON, Busan (KR); Soo Jung YOO, Busan (KR)

(72) Inventor: Jeong Hwa SON, Busan (KR)

(21) Appl. No.: 16/119,157

(22) Filed: Aug. 31, 2018

(51) Int. Cl. B01D 45/16

(52) U.S. Cl. CPC B01D 45/16

(57) ABSTRACT

A filtration system is provided, including: a casing and a guiding mechanism. The casing includes an inlet passage and an outlet passage which are arranged on an extension line. The guiding mechanism includes a first tapering portion tapered in a direction toward the inlet passage, a second tapering portion tapered in a direction toward the outlet passage and a plurality of blades. The plurality of blades extend spirally on the first tapering portion relative to the extension line. A gap is defined between the plurality of blades and an inner wall of the casing, and the gap is smaller than a height of one of the blades based on a surface of the first tapering portion.

### BACKGROUND OF THE INVENTION

### Field of the Invention

The present invention relates to a filtration system.

### Description of the Prior Art

Generally, the dust-containing gas is swirled to separate particles and gas by centrifugal force. Therefore, a conventional filtration device has a cylindrical housing and a guiding mechanism disposed in the housing for swirling the dust-containing gas. The filtration efficiency to the dust-containing gas depends on the structure of the guiding mechanism and its cooperation with the housing. However, the conventional filtration device has a poor configuration of housing and guiding mechanism and cannot effectively utilize the swirly flow to separate the particles and gas, which results in poor filtration efficiency.

The present invention is, therefore, arisen to obviate or at least mitigate the above-mentioned disadvantages.

### SUMMARY OF THE INVENTION

The main object of the present invention is to provide a filtration system which has high separation efficiency.

To achieve the above and other objects, the present invention provides a filtration system, including: a casing and a guiding mechanism. The casing includes an inlet passage and an outlet passage which are arranged on an extension line. The guiding mechanism includes a first tapering portion tapered in a direction toward the inlet passage, a second tapering portion tapered in a direction toward the outlet passage and a plurality of blades. The plurality of blades extend spirally on the first tapering portion relative to the extension line. A gap is defined between the plurality of blades and the casing, and the gap is smaller than a height of one of the blades based on a surface of the first tapering portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial cut-open perspective view of a preferable embodiment of the present invention;

FIG. 2 is a partial cross-sectional view of a preferable embodiment of the present invention;

FIG. 3 is a partial cross-sectional view of another perspective of a preferable embodiment of the present invention;

FIG. 4 is a stereogram of a blocking flange of a preferable embodiment of the present invention;

FIG. 5 is a side view of a guiding mechanism of a preferable embodiment of the present invention;

FIG. 6 is a schematic diagram of a two-dimensional cycloidal curve;

FIG. 7 is a schematic diagram of a three-dimensional cycloidal curve.

### DETAILED DESCRIPTION OF THE PREFERRED EMBODIMENTS

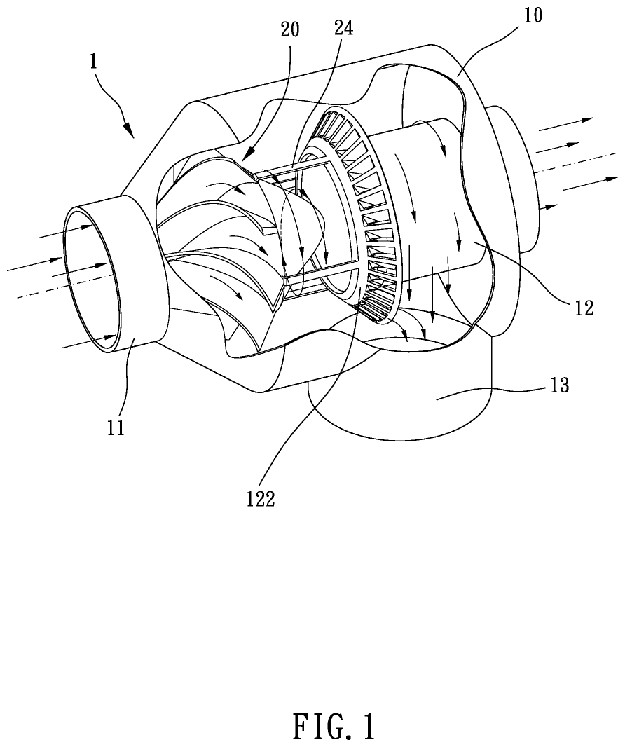

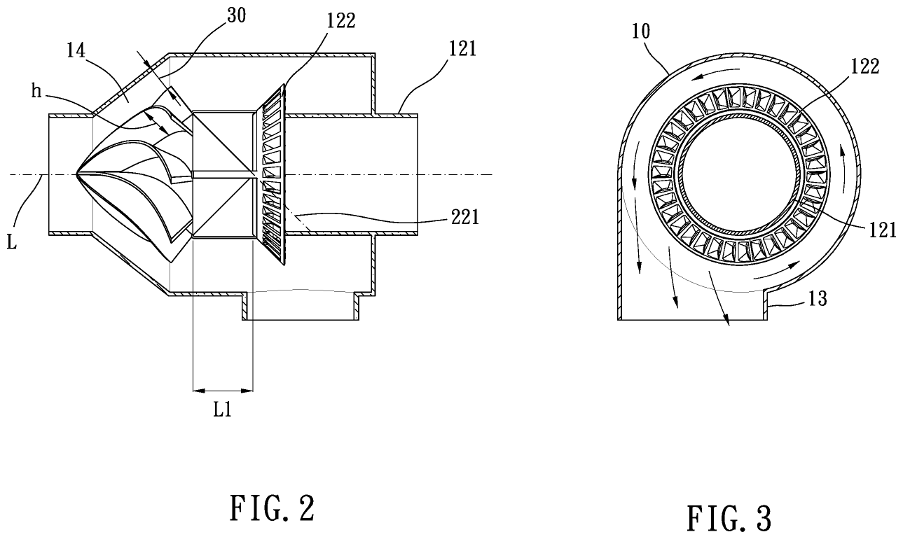

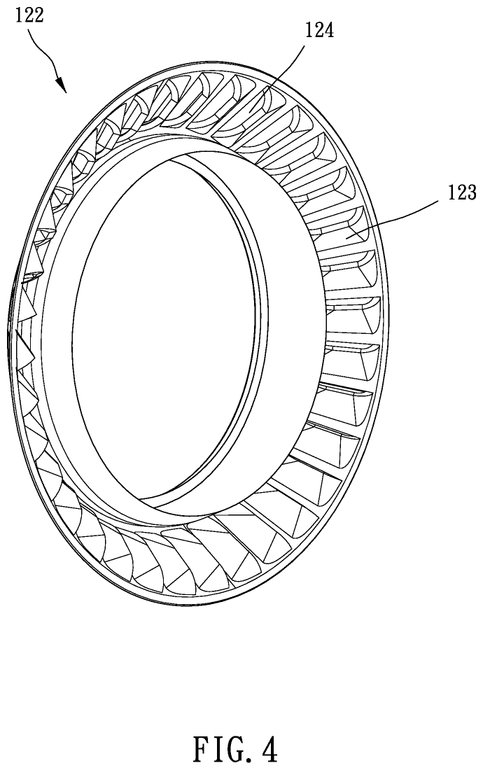

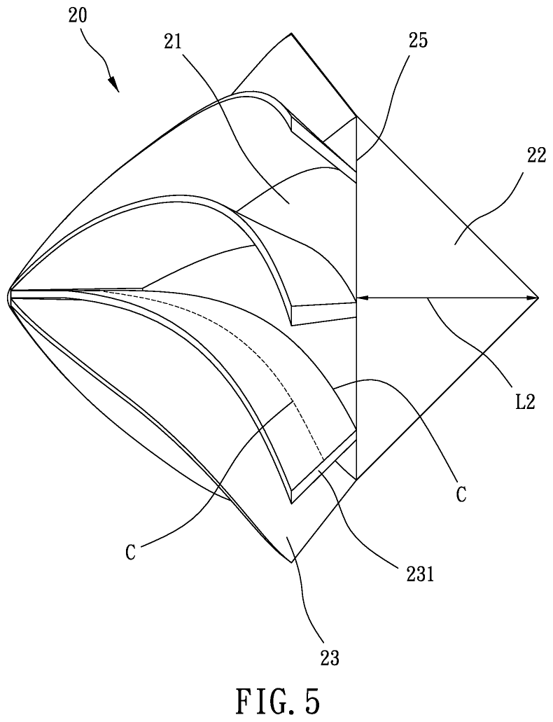

Please refer to FIGS. 1 to 5 for a preferable embodiment of the present invention. A filtration system 1 of the present invention includes a casing 10 and a guiding mechanism 20.

The casing 10 includes an inlet passage 11 and an outlet passage 12 which are arranged on an extension line L. The guiding mechanism 20 includes a first tapering portion 21 tapered in a direction toward the inlet passage 11, a second tapering portion 22 tapered in a direction toward the outlet passage 12 and a plurality of blades 23. The plurality of blades 23 extend spirally on the first tapering portion 21 relative to the extension line L. A gap 30 is defined between the plurality of blades 23 and an inner wall of the casing 10, and the gap 30 is smaller than a height h of one of the blades 23 based on a surface of the first tapering portion 21. Preferably, the casing 10, the inlet passage 11, the outlet passage 12, the first tapering portion 21 and the second tapering portion 22 each have a circular cross section so that the filtration system 1 has minimal flow resistance and kinetic energy loss and can form swirly flow. As a result, the filtration system 1 has high separation efficiency. The casing 10 further includes a particle collection passage 13 extending laterally to the extension line L. The particle collection passage 13 is preferably located radially out of the outlet passage 12 and arranged eccentrically relative to the extension line L so as to be located at a periphery of the swirly flow and increase particle collection efficiency. In this embodiment, the particle collection passage 13 is a circular tube which reduces little energy and avoids accumulation of particles. However, the particle collection passage may be shaped in other shape.

The outlet passage 12 includes a tubular member 121 connected to the casing 10 and a blocking flange 122 disposed circumferentially around the tubular member 121, and at least part of the blocking flange 122 is located within the tubular member 121 as viewed in an axial direction of the particle collection passage 13. Therefore, the blocking flange 122 can prevent the particles separated from the gas from flowing backward to the outlet passage 12 via a space between the casing 10 and the tubular member 121. Specifically, the blocking flange 122 is gradually radially broadened in a direction toward the outlet passage 12 and forms a conical surface. The blocking flange 122 has a plurality of fins 123, and extending directions of the plurality of fins 123 are in compliance with a spiral direction in which the plurality of blades 23 extend so as to effectively block the particles and discharge the particles through the particle collection passage 13. The blocking flange 122 includes a plurality of through punched holes 124, and the plurality of fins 123 are each integrally formed, by punching, as a part of the blocking flange 122 for simple structure and easy manufacturing. The plurality of through punched holes 124 allow gas circulation and provide guiding effect, and effectively avoid reverse swirly flow forming at the rear of the blocking flange 122 so as to maintain the swirly flow in the casing 10.

The casing 10 further includes a broadened portion 14 which is gradually radially broadened in a direction from the inlet passage 11 toward the outlet passage 12. Preferably, the broadened portion 14 is detachably connected to the casing 10 for convenience of assembly, replacement, clean and maintenance. The gap 30 is defined between the plurality of blades 23 and the broadened portion 14 so that the dust-containing gas can smoothly flow into the casing 10 without reducing a velocity of the swirly flow and particle accumulation. According to a type of the blades, the gap may be broadened, tapered or equidistant in a direction from the inlet passage toward the outlet passage so as to accelerate gas flow. The first tapering portion 21 and the plurality of blades 23 partially protrude into the inlet passage 11, respectively, so that the dust-containing gas can be guided and swirled in the inlet passage 11 and is not easy to block the inlet passage 11. An end surface of each of the blades 23 is preferably an incline 231 whose tilting direction is in compliance with a spiral direction in which the blades 23 extend, which minimizes the kinetics energy loss.

An extension 221 of an outer surface of the second tapering portion 22 intersects with the outlet passage 12 so as to guide the gas flow toward the outlet passage 12. The guiding mechanism 20 is connected to the outlet passage 12 by at least one supporting member 24. The filtration system 1 includes preferably a plurality of said supporting members 24. A transitional portion 25 is disposed between the first tapering portion 21 and the second tapering portion 22, and the plurality of said supporting members 24 are connected with the transitional portion 25 and the outlet passage 12 so as to improve structural stability without affecting the swirly flow (especially, a peripheral portion of the swirly flow with more particles). However, the guiding mechanism may be connected with the inner wall of the casing. In this embodiment, the first tapering portion 21 and the second tapering portion 22 are cones. A coning angle of the first tapering portion 21 is equal to or smaller than a coning angle of the second tapering portion 22. A distance L1 between the transitional portion 25 and the outlet passage 12 is equal to or smaller than two times a cone height L2 of the second tapering portion 22. With a suitable coning angle of the second tapering portion 22, de-dust gas can have a tendency to flow along the second tapering portion 22 because of Coanda effect so that the de-dust gas is discharged through the outlet passage 12, which minimizes a volume of the filtration system 1 and increases filtration efficiency.

With the structures described above, the guiding mechanism 20 can guide the dust-containing gas smoothly flows without turbulence and minimize the kinetic energy loss. When the dust-containing gas is introduced into the inlet passage 11, the plurality of blades 23 of the first tapering portion 21 guide the dust-containing gas to be swirled around the extension line L. The particles which are heavier than gas are swirled outward along a direction of inertia because of larger centrifugal force and discharged through the particle collection passage 13. The gas which is lighter than the particles is swirled at an inner region of the swirly flow and flows along the second tapering portion 22 to the outlet passage 12 because of Coanda effect, so as to shorten a flow distance of the de-dust gas and reach filtration effect. As a result, the filtration system 1 has low kinetic energy loss, small volume, easy movement and assembly/disassembly.

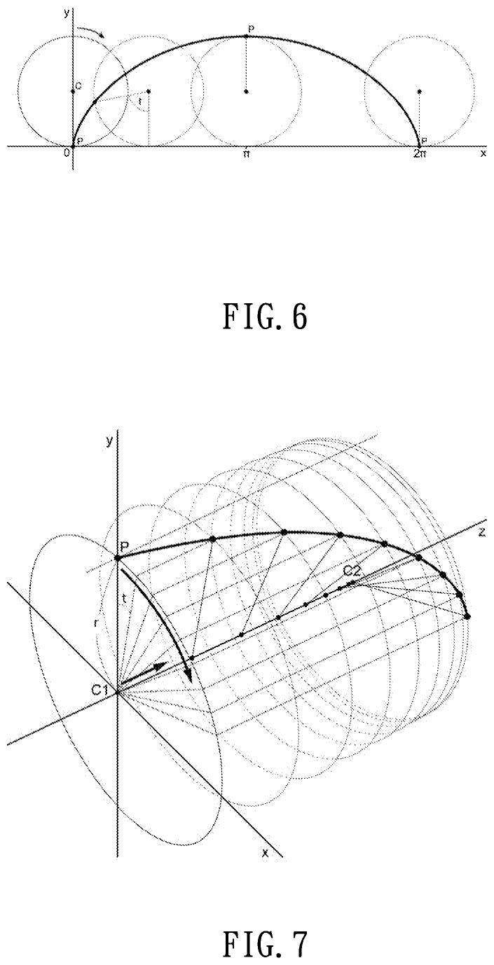

Preferably, each of the plurality of blades 23 includes a contour of cycloidal curve C which provides a shortest path when the dust-containing gas is well-diverted so as to increase the filtration efficiency. A definition of the cycloidal curve is a locus formed by a point P on a circle of radius r rolling without slide on an x-axis (as shown in FIG. 6). The cycloidal curve is expressed as a function of the rotation angle t. When the radius of the circle is r and the rotation angle is t, the function is as shown in the following [Equation 1] and [Equation 2].

x=r×(t−sin(t)) [Equation 1]

y=r×(1−cos(t)) [Equation 2]

To convert a two-dimensional cycloidal curve to a three-dimensional cycloidal curve, a differential function representing a tangential slope of each point on the cycloidal curve is a velocity function based on the cycloidal curve, as shown in following [Equation 3].

$$\frac{dy}{dx} = \frac{sin ( t )}{1 - cos ( t )} \qquad [ Equation 3 ]$$

Referring to FIG. 7, a function of a circle of radius r centered on an origin C1 on a X-Y coordinate and rotated with a rotation angle of t each time is a shown in following [Equation 4] and [Equation 5].

x=r×cos(t) [Equation 4]

y=r×sin(t) [Equation 5]

To derive the function of the three-dimensional cycloidal curve from the velocity function, the velocity function of the circle centered on the origin C1 and rotated with the rotation angle of t each time is assumed to be a z-axis. A center of the circle is moved from C1 to C2 on the z-axis and the circle is rotated with the rotation angle of t each time. On a surface of a cylinder with center at C1, radius equal to r and a height from C1 to C2, the locus of any point p on the circle forms the three-dimensional cycloidal curve whose function is as shown in following [Equation 6] to [Equation 8].

$$\begin{matrix}x = r \times cos ( t ) & [ Equation 6 ] \\ y = r \times sin ( t ) & [ Equation 7 ] \\ z = \frac{sin ( t )}{1 - cos ( t )} & [ Equation 8 ]\end{matrix}$$

The three-dimensional cycloidal curve is applied to the plurality of blades 23 of the guiding mechanism 20. The three-dimensional cycloidal curve is formed on a surface of the cone by gradually changing the radius r of the circle when drawing a three-dimensional cycloidal curve formed on a surface of a cylinder. Any cross-section of each of the blades 23 parallel to the surface of the first tapering portion 21 is located on a cycloidal curve C. Therefore, the dust-containing gas is introduced into the inlet passage 11 and flows through the plurality of blades 23 along paths with shortest retention time so as to reduce the kinetic energy loss caused by friction. The filtration system 1 has preferable filtration effect and can reduce power required to deliver the dust-containing gas to the filtration system 1. Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A filtration system, including:
a casing, including an inlet passage and an outlet passage which are arranged on an extension line;
a guiding mechanism, including a first tapering portion tapered in a direction toward the inlet passage, a second tapering portion tapered in a direction toward the outlet passage and a plurality of blades, the plurality of blades extending spirally on the first tapering portion relative to the extension line, a gap being defined between the plurality of blades and an inner wall of the casing, and the gap being smaller than a height of one of the blades based on a surface of the first tapering portion.

2. The filtration system of claim 1, wherein the casing further includes a particle collection passage extending laterally to the extension line, and the particle collection passage is located radially out of the outlet passage.

3. The filtration system of claim 2, wherein the outlet passage includes a tubular member connected to the casing and a blocking flange disposed circumferentially around the tubular member, and at least part of the blocking flange is located within the tubular member as viewed in an axial direction of the particle collection passage.

4. The filtration system of claim 3, wherein the blocking flange is gradually radially broadened in a direction toward the outlet passage.

5. The filtration system of claim 3, wherein the blocking flange has a plurality of fins, extending directions of the plurality of fins are in compliance with a spiral direction in which the plurality of blades extend.

6. The filtration system of claim 5, wherein the blocking flange further includes a plurality of through punched holes, and the plurality of fins are each integrally formed, by punching, as a part of the blocking flange.

7. The filtration system of claim 1, wherein the casing further includes a broadened portion which is gradually radially broadened in a direction from the inlet passage toward the outlet passage, and the gap is defined between the plurality of blades and the broadened portion.

8. The filtration system of claim 7, wherein the first tapering portion and the plurality of blades partially protrude into the inlet passage, respectively.

9. The filtration system of claim 1, wherein an extension of an outer surface of the second tapering portion intersects with the outlet passage.

10. The filtration system of claim 1, wherein the guiding mechanism is connected to the outlet passage by at least one supporting member.

11. The filtration system of claim 1, wherein an end surface of each of the blades is an incline whose tilting direction is in compliance with a spiral direction in which the blades extend.

12. The filtration system of claim 6, wherein the blocking flange is gradually broadened in a direction toward the outlet passage; the casing further includes a broadened portion which is gradually broadened in a direction from the inlet passage toward the outlet passage, and the gap is defined between the plurality of blades and the broadened portion; the first tapering portion and the plurality of blades partially protrude into the inlet passage;
a surface extension of the second tapering portion pass through the outlet passage; the guiding mechanism is supportedly connected with the outlet passage by at least one supporting member; the filtration system includes a plurality of said supporting members; a transitional portion is disposed between the first tapering portion and the second tapering portion, the plurality of said supporting members are connected with the transitional portion and the outlet passage; the first tapering portion and the second tapering portion are cones; a coning angle of the first tapering portion is equal to or smaller than a coning angle of the second tapering portion; a distance between the transitional portion and the outlet passage is equal to or smaller than two times a cone height of the second tapering portion; an end surface of each of the blades is an incline, and a tilting direction of each of the said inclines is in accordance with the spiral direction of the blades.

13. The filtration system of claim 1, wherein each of the plurality of blades includes a contour of cycloidal curve.

14. The filtration system of claim 13, wherein any cross-section of each of the blades parallel to the surface of the first tapering portion is located on a cycloidal curve.
